(19) United States
(12) Patent Application Publication
(10) Pub. No.: US 2011/0206560 A1
(43) Pub. Date: Aug. 25, 2011

(54) BIOSENSOR WITH MULTI-CHAMBER CARTRIDGE

(75) Inventors: Jacobus Hermanus Maria Neijzen, Heeze (NL); Reinhold Wimberger-Friedl, Veldhoven (NL); Joost Hubert Maas, Helmond (NL); Jeroen Hans Nieuwenhuis, Waalre (NL); Dominique Maria Bruls, Eindhoven (NL); Albert Hendrik Jan Immink, Eindhoven (NL); Mikhail M. Ovsyanko, Eindhoven (NL)

(73) Assignee: KONINKLIJKE PHILIPS ELECTRONICS N.V., EINDHOVEN (NL)

(21) Appl. No.: 13/126,000

(22) PCT Filed: Oct. 27, 2009
(86) PCT No.: PCT/IB09/54740

§ 371 Date: Apr. 26, 2011

(30) Foreign Application Priority Data
Oct. 31, 2008 (EP) 08168059.7

(51) Int. Cl. G01N 30/00

(52) U.S. Cl. 422/69

(57) ABSTRACT

The present invention provides a biosensor comprising a cartridge for accommodating a fluid sample, the cartridge comprising at least two chambers, wherein each chamber comprises a sensor surface with one or more binding sites. The biosensor further comprises means for generating a magnetic field at the binding sites of the sensor surfaces of the at least two chambers. The biosensor also comprises means for detecting particles accumulated at/and or proximate the binding sites of the sensor surfaces of the at least two chambers. Therein, the magnetic field at the binding sites has a sufficiently large gradient to actuate magnetic label particles towards the binding sites.

### FIELD OF THE INVENTION

The present invention is related to a multi-chamber cartridge in which different markers can be measured in fully separated measurement chambers.

### BACKGROUND OF THE INVENTION

The present invention relates to biosensors for the detection of specific components in, e.g., body fluids like saliva, urine or blood. The biosensor makes use of magnetic label particles such as superparamagnetic beads which are covered with capture probes. The specific components to be detected are supposed to bind to those capture probes. Specific magnetic actuation schemes are then applied to optimize the assay performance. The presence of target molecules to be detected in the sample is detected by the degree of binding of the magnetic label particles to specific detection spots or binding sites which are covered with specific probes or reagents. The presence of the magnetic label particles bound to the detection spot or sensor surface is detected by optical means, e.g., by FTIR (frustrated total internal reflection).

In the specific example of cardiac application the biosensor uses a blood sample taken from a finger prick for the quantitative detection of a number of biomarkers that are indicative for the occurrence of a myocardial infarct. The biosensor may be used in a point-of-care setting, such as an emergency room, bedside, ambulance, physician's office or even at home. Several important cardiac marker proteins have been identified and are routinely used in the current. Troponin I is widely used as a standard biomarker based on its absolute cardiac specificity and its long serum half-life. A fast increase of the myoglobin level in bloodstream following heart attack enables a rapid patient stratification. B-type natriuretic peptide is useful for the emergency diagnosis of heart failure and for the prognosis in patients with acute coronary syndromes. 2,3 C-reactive protein is an important prognostic indicator of coronary heart disease and acute coronary syndromes.

A simultaneous quantification of such cardiac markers allows clinicians to diagnose coronary heart disease quickly and to accurately design a patient care strategy. Thus, a fast and reliable detection system for cardiac markers will help medical professionals to differentiate between patients showing similar symptoms. In general, different markers are present in different diagnostically relevant concentrations and can thus require different assay conditions for an optimal lower limit of detection and dynamic range.

### SUMMARY OF THE INVENTION

It is thus an object of the present invention to provide an improved biosensor. It is a further object of the present invention to provide a biosensor which allows simultaneous quantification of different markers in a fast and reliable way. These objects are achieved by the features of the claims.

The present invention is related to a multi-chamber cartridge in which different markers can be measured in fully separated measurement chambers. Due to the separation of the reaction chambers cross reactivity effects are avoided and assay conditions can be optimized individually.

A general approach to detect a number of different target molecules simultaneously is to use separate detection spots or bindings sites covered with different specific reagents such as, e.g., antibodies. The presence of target molecules on the detection spots is indicated by the magnetic labels that are bound to the target molecules. The concentration of magnetic label particles on those detection spots is optically measured for each of the individual spots by imaging the spots on a camera sensor. Thus, the amount of the different target molecules present in the sample can be measured by analyzing the signal at the different detection spots.

Typically, magnetic actuation by a lower magnet located under the sample is used to accelerate the assay. An upper magnet located above the sample is preferably used to perform a magnetic washing step. Evidently, the detection spots or binding sites for the magnetic label particles have to be located in the so-called “sweet spot” of the magnet. This necessitates the individual binding sites to be concentrated in a relatively small area. Furthermore, the effective use of a single CMOS sensor on which the spots are imaged is easier when the separation between the binding sites is small.

Only a limited distance between the pole shoes of the different magnets is allowed to create magnetic fields which are strong enough for magnetic actuation. This favors a flat cartridge and a flat detection chamber design. At the same time it is advantageous to have the individual detection spots or binding sites in fully separated measurement chambers so that the assay conditions can be optimized for each chamber individually. The optimum volume and geometry of the measurement chambers is influenced by two additional factors: at least one dimension of the measurement chamber has to be small enough to create sufficient capillary force for autonomous flow of the fluid sample, e.g. plasma, into the detection chamber. At the same time the volume of each measurement chamber must be large enough to meet sensitivity requirements, i.e. to ensure that there are enough target molecules present within the sample volume. This all leads to conflicting geometrical requirements. In addition, the orientation of the actuation magnets must be such that the optical path for the optical detector beam is not obstructed.

In order to meet the above-mentioned requirements the discrete and fully separated detection chambers are configured in such a way that at least the binding sites of the detection chambers are located within the “sweet spot” of the actuation magnet. At the same time the magnets are oriented such that the optical path of the readout beam is not obstructed. In this way, the total area and volume of a detection chamber is not limited by the size of the sweet spot of the magnet.

The “sweet spot” of the magnet is in general defined by several requirements of the magnetic field generated by the magnet. The binding sites must be situated in a region where the magnetic force onto the magnetic label particles is sufficiently strong to guarantee rapid actuation. In addition, the direction of the magnetic force must be perpendicular to the surface containing the detection spots or binding sites and should not vary strongly over the sweet spot area. Since the magnetic force onto the magnetic label particles is determined by the square of the gradient of the magnetic field, the above requirements concern the gradient of the magnetic field.

If the magnetic field gradient is generated using a horse shoe magnet, the typical distance between the horse shoe magnet and the detection spot is about 1 mm due to the wall thickness of the cartridge. A maximum field gradient is then realized by optimizing the distance between the horse shoe pole tips (which is also of the order of 1 mm) and by choosing the material for the pole tips with the highest magnetic flux saturation value without the occurrence of a remanent magnetic field. These optimal geometrical and material choices allow for a maximum field gradient of about 60 T/m with a peak-valley deviation of about 10% over an area of 1 mm×1 mm. Under practical conditions the field gradient may be chosen somewhat lower to limit the heat dissipation in the coils. The tips of a horse shoe magnet may be extended in the direction perpendicular to the shortest line connecting the pole tips, creating an elongated sweet spot. In this case the area for which the field gradient of about 60 T/m has a peak-valley deviation of about 10% is preferably larger than 1 mm in one of the two directions.

Furthermore, optical requirements regarding the optical detection technique apply. Of course, the binding sites must be within the field of view of the optical detector. If one uses an inexpensive CMOS detector which has a limited number of pixels, the binding sites should be as closely packed as possible in order to allow for a large number of pixels per binding site. Preferably, the width of the field of view is between 1 and 2 mm. In case of a strongly elongated magnetic sweet spot , the field of view of the optical detection system must be adapted accordingly. Optical means may be used to effectively elongate the field of view and still make effective use of the CMOS detector.

The present invention provides a biosensor comprising a cartridge for accommodating a fluid sample, the cartridge comprising at least two chambers, wherein each chamber comprises a sensor surface with one or more binding sites. The biosensor further comprises means for generating a magnetic field at the binding sites of the sensor surfaces of the at least two chambers. The biosensor also comprises means for detecting particles accumulated at/and or proximate the binding sites of the sensor surfaces of the at least two chambers. Therein, the magnetic field at the binding sites has a sufficiently large gradient to actuate magnetic label particles towards the binding sites.

Preferably, the magnetic field gradient at the binding sites is larger than 40 T/m, preferably larger than 50 T/m and most preferably about 60 T/m. It is also preferred that the magnetic field gradient at the binding sites has a maximum-to-minimum variation of less than 20%, preferably less than 15% and most preferably of about 10%. The fraction of the sensor surface area containing the binding sites in each of the detection chambers has an area of at least 0.05 mm² , preferably larger than 0.25 mm² and most preferably larger than 2 mm².

The magnetic force generated by the magnetic field gradient at the binding sites is preferably substantially perpendicular to the sensor surfaces.

According to a particularly preferred embodiment of the biosensor according to the present invention, the chambers of the cartridge are substantially not in direct fluid communication with each other. In other words, the chambers are separated from each other, although they may be in “indirect” fluid communication via inlet channels to the chambers which may connect at some part of the cartridge. Preferably, the two or more chambers are fully separated from each other.

The detection means preferably comprises an optical detector. The optical path between the optical detector and each of the binding sites is preferably not obstructed by the means for generating a magnetic field.

The means for generating a magnetic field comprises one or a combination of the following: horse shoe magnet, trident magnet, quadrupole magnet, multipole magnet. It is preferred, that the means for generating a magnet field comprises one or more electromagnetic coils with a core, wherein the cores of the coils have a shape adapted to provide a high magnetic field gradient at the binding sites. According to a preferred embodiment of the present invention the means for generating a magnetic field is movable with respect to the cartridge.

According to a particularly preferred embodiment of the present invention the one or more binding sites of the sensor surfaces contain a reagent or a combination of several reagents. The reagents may be antibodies, antigens, proteins, recombinant proteins, etc. Preferably, the reagent or combination of several reagents at the one or more binding sites is different for different chambers. Thus, different assays can be performed in the different chambers. Preferably, the cartridge comprises three, four, five or more chambers. Each of those chambers preferably comprises a sensor surface with two, three, four or more binding sites. Of course, other arrangements with more chambers and/or more binding sites per chamber shall fall under the scope of protection as well. According to a preferred embodiment of the invention, each binding site within one chamber contains a different reagent or a different combination of several reagents. Thus, a complex analysis may be performed wherein several different markers are measured simultaneously.

As will become apparent from the description of the preferred embodiments, the present invention also provides for a specific arrangement of the measurement chambers with respect to each other and to the actuation magnet(s), in particular to the sweet spot of the actuation magnet(s). In order to fulfill the above-mentioned conflicting geometrical requirements, the chambers of the cartridge are arranged in such a manner that the binding sites of the sensor surfaces are located in the sweet spot of the actuation magnet, whereas another portion of the chambers preferably lies outside this sweet spot. Thus, the actuation properties may be optimized whilst at the same time the volume of the measurement chambers is large enough to meet the sensitivity requirements.

The present invention will be further elucidated with reference to the following Figures through the description of the preferred embodiments.

### BRIEF DESCRIPTION OF THE DRAWINGS

FIG. 1 shows a top view of a horse shoe magnet which may be used in a biosensor according to the present invention.

FIG. 2 shows a top view of a trident magnet which may be used in a biosensor according to the present invention.

FIG. 3 schematically shows a top view of a preferred embodiment of a biosensor according to the present invention.

FIG. 4 shows a top view of another preferred embodiment of a biosensor according to the present invention.

FIG. 5 shows a top view of another preferred embodiment of a biosensor according to the present invention.

FIG. 6a shows another preferred embodiment of a biosensor according to the present invention.

FIG. 6b shows another preferred embodiment of a biosensor according to the present invention.

FIGS. 7 to 10 schematically show alternative designs of the chambers of the biosensor according to the present invention.

FIG. 11a shows a side view of a preferred embodiment of the biosensor according to the present invention with a horse shoe magnet.

FIG. 11b shows a side view of another preferred embodiment of the biosensor according to the present invention with a trident magnet.

FIG. 12a shows a top view of the fluidic part of a biosensor according to the present invention.

FIG. 12b shows a front view of the cartridge of a biosensor according to the present invention.

FIG. 12c shows a top view of the optical part of a biosensor according to the present invention.

FIG. 12d shows a side view of the cartridge of a biosensor according to the present invention.

### DETAILED DESCRIPTION OF EMBODIMENTS

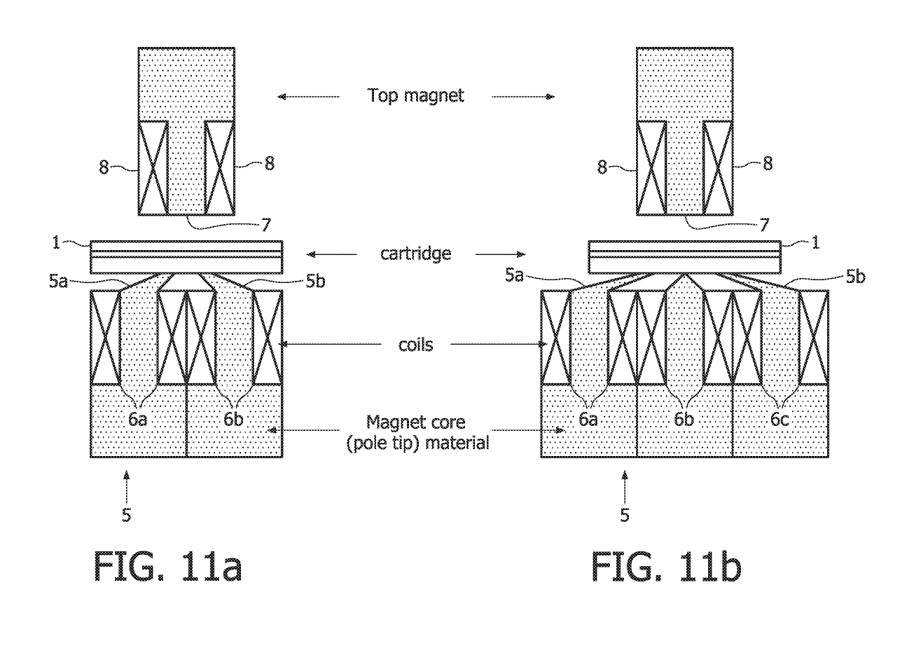

FIG. 11a shows a schematic side view of a preferred embodiment of a biosensor according to the present invention. The cartridge 1 is sandwiched between the lower horse show magnet, which is used for actuation, and the upper washing magnet. The upper washing magnet comprises a magnet core 7 surrounded by a coil 8. The lower magnet 5 is a horse shoe magnet comprising two magnet cores with pole tips 5a and 5b. The cores are surrounded by coils 6a and 6b. The pole tips 5a and 5b of the magnet core are shaped in order to provide a large magnetic field gradient in the cartridge 1.

FIG. 11b shows an alternative to the embodiment shown in FIG. 11a. In FIG. 11b, the horse shoe magnet of FIG. 11a has been replaced by a trident magnet 5. The trident magnet 5 comprises three magnet cores with coil tips 5a, 5b and 5c, each of which are shaped to provide a large magnetic field gradient at the cartridge 1. The magnet cores are surrounded by coil 6a, 6b and 6c.

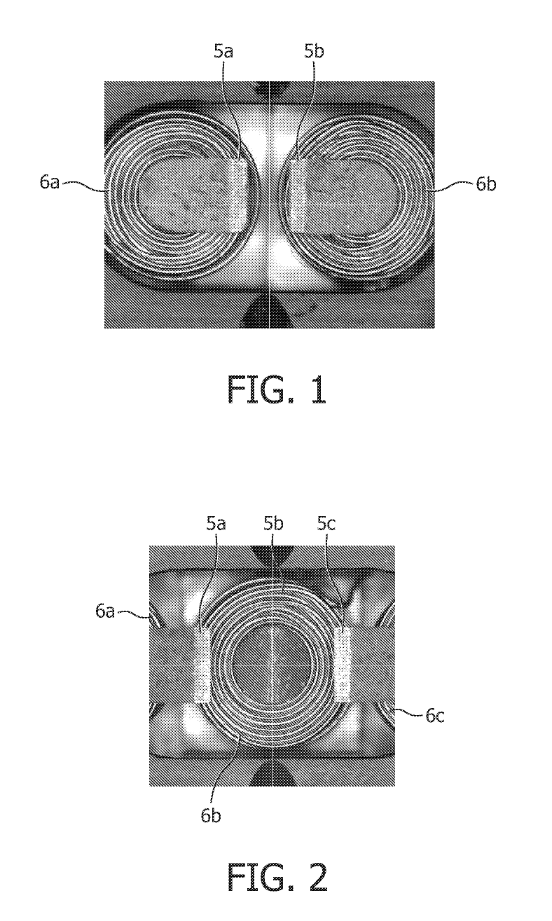

FIGS. 1 and 2 show top views of the magnets shown in FIGS. 11a and 11b, respectively.

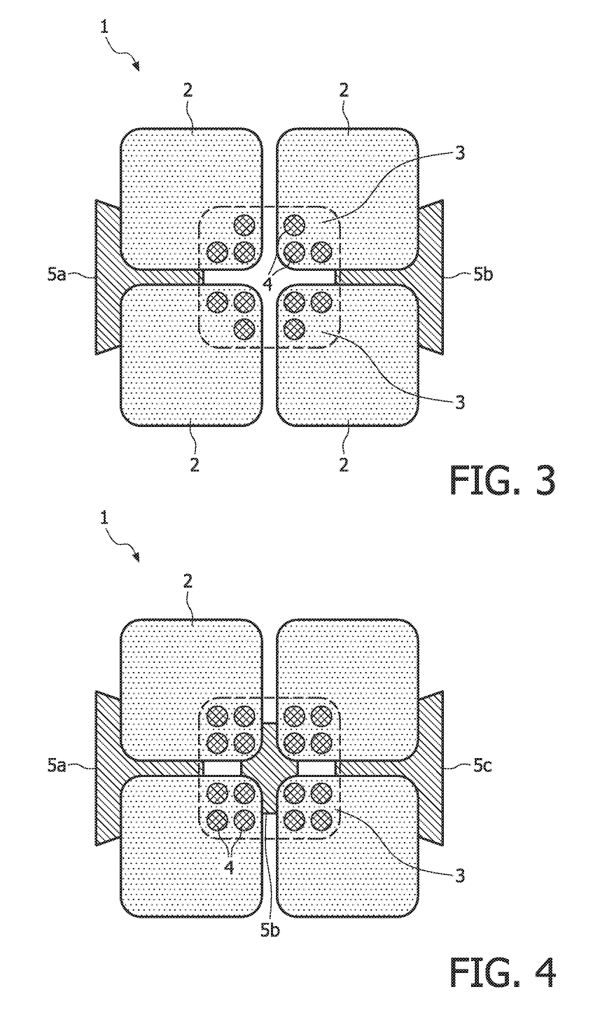

FIG. 3 shows a schematic representation of a biosensor with a four-chamber configuration according to the present invention. The cartridge 1 comprises four chambers 2 which are arranged in a square configuration. Each chamber 2 comprises a sensor surface 3 with three binding sites 4. Under the chambers 2 the pole tips 5a and 5b of a horse shoe magnet are sketched. The sweet spot of the horse shoe magnet, i.e. the area which is suitable for magnetic actuation, is indicated by a dashed line. Apparently, the sweet spot is much smaller than the area covered by the four chambers 2. However, since the four chambers 2 are arranged in a square pattern and the binding sites 4 are located in the corners of the chambers 2, all the binding sites 4 are located in the sweet spot. Accordingly, the magnetic field at the binding sites 4 has a sufficiently large gradient to actuate magnetic label particles towards the binding sites. At the same time the volume of each chamber 2 is large enough to meet the sensitivity requirements, i.e. to provide enough target molecules within the sample volume. Since the four chambers 2 are separated from each other, cross reactivity effects can be avoided and assay conditions optimized individually for each chamber 2.

FIG. 4 shows a similar arrangement of four chambers 2 in a square pattern above a trident magnet. While FIG. 3 shows three binding sites 4 per chamber 2 and FIG. 4 four binding sites 4 per chamber 2, it should be apparent that the number of binding sites per chamber may vary. The assay conditions, i.e. reagents, magnetic label particles and the like, can be different in each chamber 2. The orientation of the chambers 2 with respect to the magnet shown in FIGS. 3 and 4 makes optimal use of the actuation sweet spot, while the footprint and height of the chambers 2 can still be adapted to the sensitivity and capillary filling demands.

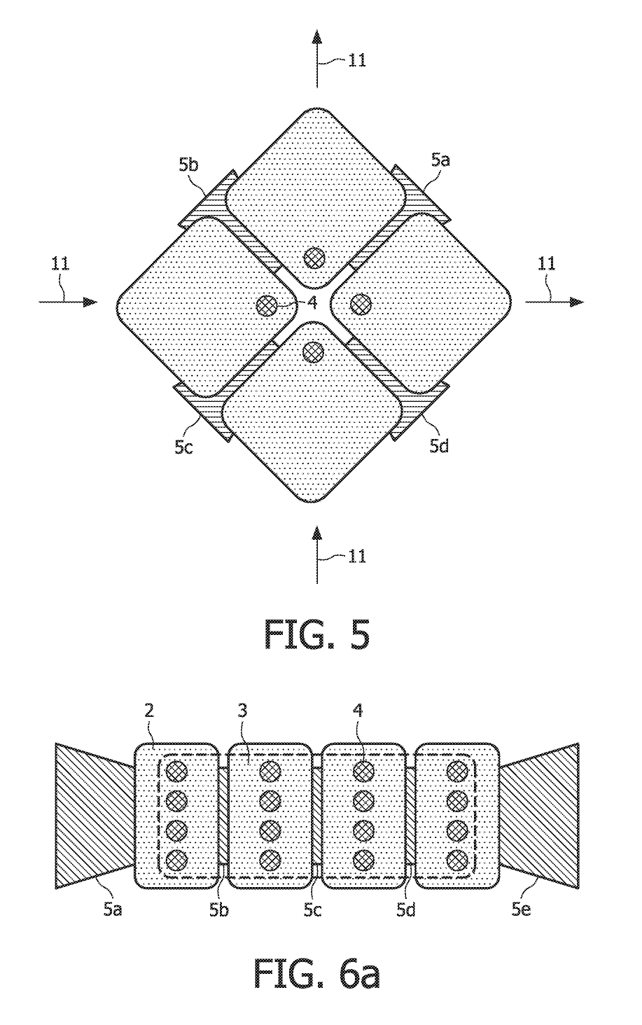

In case of a single horse shoe actuation magnet all binding sites will be subjected to the same actuation protocol. If, however, a quadrupole magnet as shown in FIG. 5 is used, the actuation protocol of each chamber 2 may be optimized individually. The embodiment shown in FIG. 5 has a diagonal orientation of the chambers 2 with respect to the readout beam 11. This allows the use of a quadrupole actuation magnet without blocking the optical path of the readout beam 11.

If a horse shoe or trident actuation magnet (cf. FIGS. 3 and 4) is used the chambers of the cartridge may have a parallel orientation with respect to the readout beam as well.

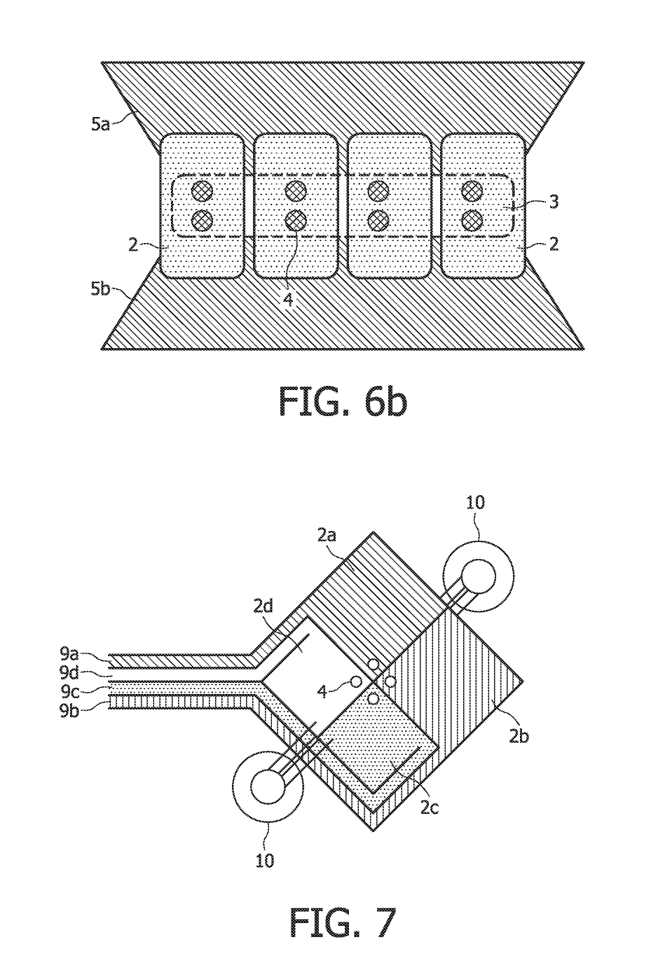

In case of a linear multipole magnet as shown in FIG. 6a (which comprises five magnet poles 5a, 5b, 5c, 5d and 5e), the chambers 2 can be oriented in line using a single elongated detection area. FIG. 6b shows an embodiment with an extended horseshoe magnet resulting in an elongated magnetic sweet spot and using a single elongated detection area 3. It should be apparent that the number of chambers 2 in case of the embodiment shown in FIG. 6b may be varied. For example, 2, 3, 4, 5, 6 or even more chambers 2 may be arranged between the two extended or elongated poles 5a and 5b of the horse shoe magnet.

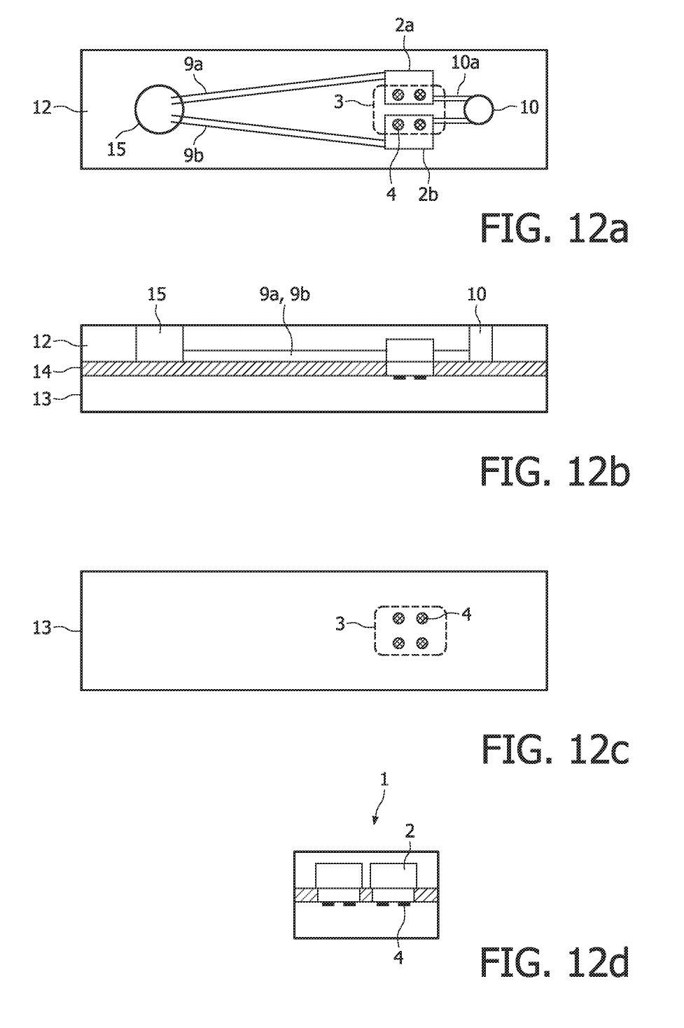

A more detailed drawing of a cartridge according to the present invention also showing the supply and exhaust channels of the chambers is shown in FIG. 7. The cartridge preferably comprises a fluidic part 12 and an optical part 13 which may be assembled using double-sided tape 14 as shown in the front view of FIG. 12b. The fluidic and optical parts 12 and 13 are preferably made by injection molding of polymers like polystyrene, polycarbonate, cyclo-olefin (co-)polymer, polypropylene, ABS and the like. The same or different polymers may be used for the fluidic part 12 and the optical part 13. The optical part 13 is preferably made of a transparent material. In the fluidic part 12 bead or particle wells are present inside each chamber for convenient storage of dry reagents and functionalized magnetic beads.

As can be taken from the top view of the fluidic part 12 shown in FIG. 12a, the fluidic part 12 preferably comprises a sample inlet 15, which is connected via inlet or supply channels 9a and 9b to the chambers 2a and 2b. The chambers 2a and 2b comprise a sensor surface 3 with several binding sites 4 as discussed above, which are contained on the optical part 13 as seen in FIG. 12c. The chambers 2a and 2b are connected to a vent 10 via venting or exhaust channels 10a. Alternatively, each chamber has its own vent 10 (cf. FIG. 7).

The fluidic part 12 and the optical part 13 may be attached to each other via a double-sided tape, which connects the two cartridge parts. However, other ways to form a cartridge from the fluidic part and the optical part are conceivable as well. In FIGS. 12a through 12d the channels and chambers are formed in the fluidic part 12, whereas the sensor surface with the binding sites is contained on the optical part 13. Although this is a preferred arrangement, another cartridge design does also fall under the scope of the present invention.

With respect to FIG. 12a it will also be apparent how the “indirect” fluid communication via inlet channels discussed in the Summary is to be understood. As can be taken from FIG. 12a, the two chambers 2 of the cartridge 1 are fully separated from each other. However, there is a fluid path from chamber 2a over inlet channel 9a, inlet 15 and inlet channel 9b towards chamber 2b. Nevertheless, the chambers of the cartridge are substantially not in direct fluid communication with each other and cross reactions between the chambers can be avoided.

Assay chemistry will typically include salts, buffers, detergents, enzymes, stabilizing agents and bactericides. To prevent cross contamination of the different chambers double-sided tape may be used to connect the optical and fluidic part together. This results in an array format where different capture probes specific for each of the targeted analytes are immobilized in discrete areas. Simultaneous assays can be used in this fully integrated system, leading to simultaneous multiple determinations in a single drop, e.g., of blood.

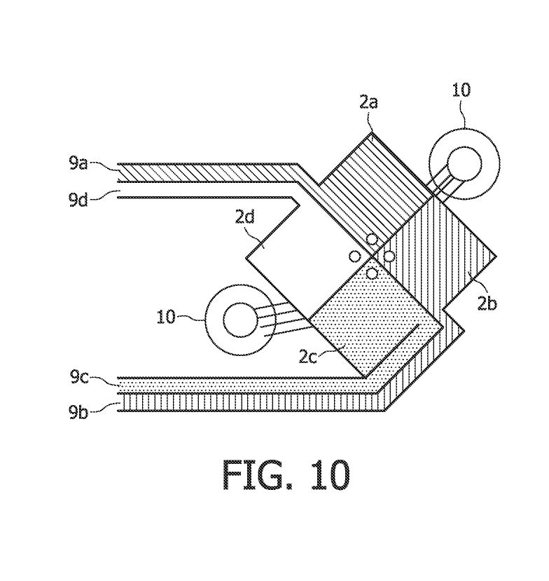

Several preferred designs for the arrangement of the chambers and the channels of the cartridge according to the present invention are shown in FIGS. 7 to 10. Therein, the chambers, channels and vents are again preferably provided in a fluidic part as discussed above with reference to FIGS. 12a to 12d, whereas the sensor surface with the binding sites, which are also indicated in FIGS. 7 to 10, are preferably contained on or in a separate optical part. As can be seen in the preferred embodiment of FIG. 7, each of the chambers 2a, 2b, 2c and 2d are provided with a respective supply channel 9a, 9b, 9c and 9d. Furthermore, the cartridge is provided with vent or exhaust channels leading to vents 10.

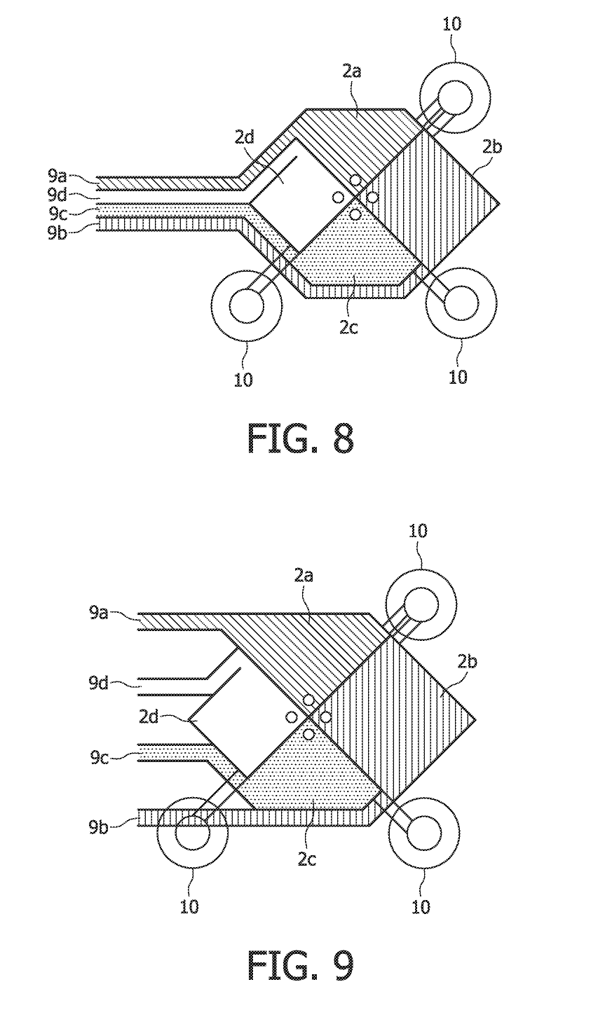

Of course, there are plenty of different possibilities to design four chambers and four supply channels. Some of those possibilities are sketched in FIGS. 8-10. All conceivable alternatives to the embodiments shown in the present application shall fall under the scope of protection as long as the binding sites of the different chambers are located in the sweet spot of the actuation magnet(s).

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measured cannot be used to advantage. Any reference signs in the claims should not be construed as limiting the scope.

1. A biosensor comprising:
a) a cartridge (1) for accommodating a fluid sample, the cartridge (1) comprising at least two chambers (2), each chamber (2) comprising a sensor surface (3) with one or more binding sites (4);
b) means (5) for generating a magnetic field at the binding sites (4) of the sensor surfaces (3) of the at least two chambers (2); and
c) means for detecting particles accumulated at and/or proximate the binding sites of the sensor surfaces of the at least two chambers;
wherein the magnetic field at the binding sites (4) has a sufficiently large gradient to actuate magnetic label particles towards the binding sites.

2. Biosensor according to claim 1, wherein the magnetic field gradient at the binding sites has a maximum-to-minimum variation of less than 20%, preferably less than 15% and most preferably of about 10% over the fraction of the sensor surface area containing the binding sites.

3. Biosensor according to claim 2, wherein the fraction of the sensor surface containing the binding sites has an area per chamber of at least 0.05 mm², preferably larger than 0.25 mm² and most preferably larger than 2 mm².

4. Biosensor according to claim 1, wherein the magnetic field gradient at the binding sites is larger than 40 T/m, preferably larger than 50 T/m and most preferably about 60 T/m.

5. Biosensor according to claim 1, wherein the magnetic force generated by the magnetic field gradient at the binding sites is substantially perpendicular to the sensor surface.

6. Biosensor according to claim 1, wherein the chambers (2) of the cartridge (1) are substantially not in direct fluid communication with each other.

7. Biosensor according to claim 1, wherein the detection means comprises an optical detector and an optical path between the optical detector and each of the binding sites is not obstructed by the means for generating a magnetic field.

8. Biosensor according to claim 1, wherein the means for generating a magnetic field comprises one or a combination of the following: horseshoe magnet, trident magnet, quadrupole magnet, multi-pole magnet.

9. Biosensor according to claim 1, wherein the means (5) for generating a magnetic field comprises one or more electromagnetic coils (6a, 6b, 6c) with a core and a pole tip (5a, 5b, 5c, 5d, 5e), wherein the pole tips (5a, 5b, 5c, 5d, 5e) have a shape adapted to provide a high magnetic field gradient at the binding sites (4).

10. Biosensor according to claim 1, wherein the means (5) for generating a magnetic field is moveable with respect to the cartridge (1).

11. Biosensor according to claim 1, wherein the one or more binding sites of the sensor surfaces contain a reagent or a combination of several reagents.

12. Biosensor according to claim 11, wherein the reagent or combination of several reagents at the one or more binding sites is different for different chambers.

13. Biosensor according to claim 1, wherein the cartridge (1) comprises 3, 4, 5 or more chambers (2).

14. Biosensor according to claim 13, wherein each chamber (2) comprises a sensor surface (3) with 2, 3, 4 or more binding sites (4).

15. Biosensor according to claim 14, wherein each binding site (4) within one chamber (2) contains a different reagent or a different combination of several reagents.
